(19) United States
(12) Patent Application Publication
(10) Pub. No.: US 2025/0051228 A1
(43) Pub. Date: Feb. 13, 2025

(54) PROCESS PLANT FOR CONVERTING A SOLID INPUT MATERIAL INTO A SOLID PROCESS PRODUCT

(71) Applicant: DÜRR SYSTEMS AG, Bietigheim-Bissingen (DE)

(72) Inventors: Urs HÄSELI, Brugg (CH); Carsten WALDDÖRFER, Eppingen (DE); Matthias HAGEN, Bad Berneck (DE)

(21) Appl. No.: 18/718,639

(22) PCT Filed: Dec. 19, 2022
(86) PCT No.: PCT/DE2022/100970

§ 371 Date: Jun. 11, 2024

(30) Foreign Application Priority Data
Dec. 21, 2021 (DE) 10 2021 134 014.4

(51) Int. Cl. C04B 7/44; B01D 53/34; B01D 53/75; B01D 53/76; B01D 53/86; C04B 7/36; C04B 7/47; F01K 25/14; F27B 7/00; F27D 17/00

(52) U.S. Cl. CPC C04B 7/4415; B01D 53/343; B01D 53/75; B01D 53/76; B01D 53/8631; B01D 53/8634; C04B 7/364; C04B 7/475; F27B 7/00; F27D 17/004; B01D 2257/404; B01D 2257/406; B01D 2258/0283; F01K 25/14; F27D 2017/009; F27M 2003/03

(57) ABSTRACT

The invention relates to a process plant (20) for converting a solid input material into a solid process product. The process plant (20) includes a calciner which is connected to a heat exchanger (26) and to which the input material can be continuously supplied for heating in order to transform the input material into an intermediate product. In the process plant (20) there is a kiln for converting the intermediate product into the process product by means of thermal treatment, raw gas being produced in doing so. The process plant (20) has a raw gas line system (50) comprising a raw gas line (50.1) which extends from the kiln to the calciner and through which the raw gas can flow from the kiln into the calciner for transferring raw gas heat to the input material, and includes a cooling device for cooling the process product after the thermal treatment in the kiln by transferring heat from the process product to a cooling gas containing oxygen, as a result of which a hot gas containing oxygen is generated. According to the invention, in the process plant (20) there is a waste air purification device for oxidizing raw gas, which is connected to the calciner via a raw gas line system (50), wherein a hot gas line system which is used for supplying hot gas generated from the cooling device is attached to the raw gas line system (50). The invention also relates to a method for converting a solid input material into a solid process product and to a method for purifying raw gas produced during the manufacture of cement.

### RELATED APPLICATIONS

This application is a national phase of International Application No. PCT/DE2022/100970, filed on Dec. 19, 2022, and claims the benefit of German Application No. 10 2021 134 014.4, filed on Dec. 21, 2021. The foregoing International Patent Application and the German Patent Application are incorporated herein by reference in their entireties.

### FIELD OF DISCLOSURE

The disclosure relates to a process plant for converting a solid input material into a solid process product, comprising a heat exchanger that is connected to a calciner, wherein the input material can be continuously supplied to the calciner via the heat exchanger for heating in order to transform the input material into an intermediate product, a kiln for converting the intermediate product into the process product by means of thermal treatment, raw gas being produced in doing so, a raw gas line system comprising a raw gas line which extends from the kiln to the calciner and through which the raw gas can flow from the kiln into the calciner, and a cooling device for cooling the process product after the thermal treatment in the kiln by transferring heat from the process product to a cooling gas containing oxygen, for example fresh air.

Furthermore, the disclosure relates to a method for converting a solid input material into a solid process product, wherein the input material is continuously supplied into a calciner and heated therein to transform the input material into an intermediate product, wherein the intermediate product is converted into the process product in a kiln by means of thermal treatment with the release of raw gas, wherein the raw gas is flowed through the calciner for the transfer of raw gas heat to the input material, and wherein the process product is cooled after the thermal treatment by means of a cooling gas containing oxygen, wherein the cooling gas is heated to form hot gas.

The disclosure also relates to a method for purifying raw gas produced during the manufacture of cement.

### BACKGROUND

In the field of cement production, examples of such process plants and methods are known for converting input material in the form of so-called raw meal, consisting of limestone or limestone meal, among other things, into the process product of clinker.

The raw meal is preferably heated in a calciner attached to a rotary kiln by means of raw gas in the form of waste gas from the rotary kiln and fuels, so that the carbon dioxide bound in the raw meal is expelled. This transforms the raw meal into an intermediate product (hot meal), which is supplied into the rotary kiln. In the rotary kiln, this intermediate product is converted into clinker as a process product at a temperature T of T≈ 1450° C., for example. With preferred further processing, this clinker is ground and mixed with aggregates such as gypsum, wherein cement is produced from the process product of the rotary kiln.

In GERHARD PHILIPP: “Regenerative Thermal Oxidation (RTO) with integrated Nox-Reduction-Regenerative Thermische Oxidation (RTO) mit integrierter Nox-Reduktion,” ZKG INTERNATIONAL-. ZEMENT-KALK-GIPS INTERNATIONAL, BAUVERLAG BV GMBH, DE, vol. 66, No. 11, Nov. 1, 2013 82013-11-01), pages 30-37, XP001591814, ISSN: 0949-0205, a process plant for the manufacture of cement clinker is described. It is stated therein that fresh air mixed with the waste air from a rotary kiln is fed into an RTO plant after filtering together with the waste air from the rotary kiln, which passes in counterflow through a calciner into a cyclone heat exchanger and from this through a silo, a further cyclone heat exchanger, a paper dryer and a mill, after filtering. The mixing of an air flow from the clinker cooler with the waste air from the rotary kiln, after the waste air from the rotary kiln has flowed through a calciner and a cyclone heat exchanger in order to then feed it to the plant system as a mixed gas, is not provided for here.

DE 10 2012 020300 A1, DE10 2014 108154 A1, DE 10 2014 012396 A1, DE 1999 62 536 A1 and DE 10 2013 006237 A1 also in each case disclose a process plant for the manufacture of cement. A mixing of hot air from a cooling device with raw gas from a kiln after the raw gas has flowed through a calciner and a heat exchanger is also not present here.

US 2008/0038682 A1 describes a plant for the manufacture of cement clinker in which a catalyst is provided in order to reduce the proportion of CO, organic components and/or NH3 and/or nitrogen oxides and/or to convert SO2 into SO3. However, this plant does not contain an RTO device.

### SUMMARY

The object of examples disclosed herein is to provide a process plant and a method for converting a solid input material into a solid process product with low energy consumption and largely without releasing pollutants into the environment. In particular, it is an object of examples disclosed herein to allow the purification of raw gas produced during the manufacture of cement, wherein no or only little energy has to be supplied from outside.

This object is achieved by the process plant indicated in claim 1 and the method specified in claim 15 and the method indicated in claim 25. Advantageous embodiments of examples disclosed herein are indicated in the dependent claims.

A process plant according to examples disclosed herein for converting a solid input material into a solid process product comprises a heat exchanger and has a calciner that is connected to the heat exchanger, wherein the input material for heating can be continuously supplied to the calciner via the heat exchanger in order to transform the input material into an intermediate product. In the process plant there is a kiln for converting the intermediate product into the process product by means of thermal treatment, raw gas being produced in doing so. The process plant includes a raw gas output system, which has a raw gas line which extends from the kiln to the calciner, through which the raw gas can flow from the kiln into the calciner. In the process plant there is a cooling device for cooling the process product after the thermal treatment in the kiln by transferring heat from the process product to a cooling gas containing oxygen, for example fresh air, as a result of which a hot gas containing oxygen is generated. In the process plant there is a waste air purification device for oxidizing raw gas, which is connected to the heat exchanger via the raw gas line system, wherein a hot gas line system which is used for supplying hot gas generated from the cooling device into the raw gas line system is attached to the raw gas line system. Examples disclosed herein also relate to a method for converting a solid input material into a solid process product.

In the present case, a calciner is understood to mean a device in which input material can be heated with fuels and supplied oxygen from oxygen-containing hot gas, for example hot air, so-called tertiary air.

Not least in cement production, strict waste gas emission limits must now be adhered to in many countries. These emission limits require not only the removal of solids from the waste gas of cement plants, but also the reduction of nitrogen oxides and/or ammonia and/or carbon monoxide components and/or volatile hydrocarbons contained therein. It has been shown that it is not possible to comply with prescribed waste gas emission limits in cement production with SNCR systems alone, which convert harmful nitrogen monoxide (NO) and nitrogen dioxide (NO2) into harmless molecular nitrogen N2 and water, and/or with bag or electrostatic precipitators.

Therefore, the inventors propose to convert the pollutants in the waste gases produced during the conversion of a solid input material into a solid process product mainly into carbon dioxide, water and nitrogen by means of regenerative thermal raw gas oxidation and to provide a waste air purification device for oxidizing raw gas in a process plant for this purpose, which can be designed, for example, as an RTO device that includes a combustion chamber and regenerators and that is designed for regenerative thermal raw gas oxidation.

Such an RTO device is particularly suitable for reducing the concentrations of carbon monoxide (CO), organic carbon compounds (VOC) and any excess ammonia (NH3) from over-stoichiometrically operated SNCR systems, and allows for strict nitrogen oxide limits to be maintained with low ammonia slip limits.

RTO devices for regenerative thermal oxidation are used in various industries to remove combustible pollutants from raw gas by oxidizing it in a combustion chamber at high temperature. The raw gas is fed into the combustion chamber through first regenerators containing a heat exchanger housed in a regenerator chamber that is used to preheat the raw gas before it enters the combustion chamber. The heat exchanger preferably comprises a heat storage mass which has been heated in a previous process step by supplying thermal energy. The heat storage mass transfers heat to the raw gas as it flows through and heats it before it enters the combustion chamber. The raw gas, which has been freed of pollutants in the combustion chamber and is also known as hot gas or hot clean gas, is then discharged as clean gas through second regenerators with a heat exchanger arranged in a regenerator chamber, with heat being transferred to the heat exchanger. Preferably, heat is transferred to a heat storage mass of this heat exchanger. When the heat exchanger in the first regenerator has cooled down to a certain extent, the plant switches over. The raw gas is then fed into the combustion chamber through the second regenerators and discharged from the first regenerators as clean gas. Depending on the composition of the raw gas, the continuous switching of the plant allows the pollutants to burn in the combustion chamber without any energy input or with only a low energy input from the outside.

Because the clean gas cools as it flows through the heat exchanger in the regenerator chamber of a regenerator, constituents from the raw gas can precipitate there that have not been burned or have only been burned incompletely in the combustion chamber or have been formed there by conversion.

In the RTO devices used in the graphite processing industry, for example, blockages of tar substances are formed in the regenerator chambers over time. For safety reasons, these cannot simply be incinerated in the regenerator chambers. In RTO devices, the regenerator chambers are therefore subjected to pyrolysis or gasification at regular intervals by increasing the temperature, for example by introducing hot clean gas from the combustion chamber or by otherwise introducing hot air, as a result of which deposits with solid and/or liquid components are transferred to the gas phase. In this way, tar substances are removed from the regenerator chambers. They are then discharged from the process plant with or without post-treatment.

Nitrogen oxides in the raw gas cannot be easily removed in a combustion chamber. To remove nitrogen oxides from raw gas, it is known to react it with ammonia in a reaction chamber at defined temperatures to form water and nitrogen. Due to temperature fluctuations and changes in the composition of the raw gas in the presence of SO₃ or HCl, for example, ammonium salts can form precipitates in the regenerator chambers of RTO devices and impair plant operation as solid and/or slimy blockages, because this reduces the performance of the heat exchangers and increases the flow resistance for the clean and raw gas. Since ammonium salts are generally water-soluble, they can be removed from the regenerator chambers of an RTO device by washout, but this in turn requires that the RTO device be shut down because elaborate heating and cooling processes have to be carried out.

Examples disclosed herein are based on the idea of supplying the air heated in the clinker cooler as so-called quaternary air in a process plant designed for the production of cement, in particular to a plant designed as an RTO plant for waste gas purification, in order to operate it in a defined temperature window and provide oxygen for oxidation. The calciner is deliberately operated with a low oxygen content, since it can only be supplied with correspondingly less tertiary air. As a result, carbon monoxide is produced in the calciner. This is desirable, since this carbon monoxide is then available as a “fuel” in the RTO plant, so that it can be operated in an autothermal operating state without an external energy supply, even with a lower general load of combustible substances in the raw gas.

The inventors have recognized that, in principle, supplying hot air heated in the cooling device to the raw gas output system connecting the RTO device for regenerative thermal raw gas oxidation to the heat exchanger allows the gas temperature and oxygen content of raw gas upstream of the RTO device to be increased. In particular, the inventors have recognized that autothermal operation of the RTO device can be achieved by ensuring incomplete combustion in the calciner, with which the hot air supplied into it as tertiary air is reduced. Autothermal operation of the RTO device is possible in normal operation without the temperature of the raw gas in the raw gas line system being close to the sulphuric acid dew point, which would make corrosion protection necessary for the assemblies arranged in the raw gas line system.

This makes it possible, for example, to dispense with the desulphurization of raw gas in the raw gas line system by means of scrubbers or dry sorption, the use of expensive and difficult-to-process corrosion-resistant materials and the preheating of raw gas supplied into the RTO device in heat exchangers and the use of additional fuels such as natural gas in the RTO device.

Preferably, the hot gas line system for supplying the hot gas generated in the cooling device to the calciner includes a tertiary air hot gas line which is attached to the first raw gas line, so that hot gas generated in the cooling device can be supplied through the calciner to the heat exchanger.

Through this tertiary air hot gas line, which acts as a tertiary line for the hot gas, the calciner can be supplied with oxygen for the combustion of the supplied fuels from the hot gas.

By providing a flow control device for adjusting the quantity of hot gas supplied to the calciner through the tertiary air hot gas line, it can be achieved that the oxygen content and/or the temperature of the raw gas supplied to the waste air purification device for oxidizing can be adjusted.

By adjusting the quantity of hot gas supplied into the calciner, incomplete combustion can be achieved in order to provide carbon monoxide as fuel for the downstream RTO device for waste air purification.

The hot gas line system for supplying the hot gas generated in the cooling device through at least one hot gas line can communicate with at least one raw gas line in the raw gas line system, through which raw gas from the heat exchanger can flow into the waste air purification device. The raw gas line can connect the heat exchanger to a raw gas cooling device arranged in the raw gas line system for cooling the raw gas supplied to the waste air purification device.

The hot gas line system for supplying the hot gas generated in the cooling device communicates through at least one quaternary air hot gas line with at least one raw gas line in the raw gas line system, through which raw gas from the heat exchanger can flow into the waste air purification device.

The quaternary air hot gas line can include a flow control device that is used for adjusting a flow rate of hot gas generated in the cooling device through the quaternary air hot gas line, in order to thereby adjust the temperature and/or oxygen content of the raw gas flowing through the at least one raw gas line to the waste air purification device.

The at least one raw gas line can connect the heat exchanger to a raw gas cooling device arranged in the raw gas line system for cooling the raw gas supplied to the waste air purification device.

An ORC system arranged in the raw gas line system, to which raw gas can be supplied from the heat exchanger through the at least one raw gas line and hot gas can be supplied from the at least one quaternary air hot gas line, in order to convert the heat entrained therein into mechanical and/or electrical energy, is advantageous. In this way, the residual heat of the raw gas flowing out of the calciner can be used to generate electrical or mechanical energy.

The at least one quaternary air hot gas line can open into the raw gas line in the raw gas line system, which is used to supply raw gas cooled in the raw gas cooling device to the waste air purification device.

The process plant can include a separating device that is used to separate particles, in particular solids, from the raw gas flowing from the heat exchanger into the waste air purification device. This separating device can, for example, be designed as a filter for filtering out solid particles from a gaseous fluid. The separating device can also be designed as a particle separator or as a cyclone for filtering out solid particles from a gaseous fluid. By means of the raw gas cooling device and the ORC system, it can be ensured that the temperature of the raw gas entering the separating device does not reach values that could damage the separating device.

By the process plant containing an SNCR device for purifying raw gas guided through the raw gas line system, which is used for converting nitrogen oxides and ammonia contained in the raw gas into molecular nitrogen and water, it can be achieved that the process plant releases no or only little nitrogen oxides to the environment. The SNCR device is preferably arranged in the calciner.

It is advantageous if the RTO device has a combustion chamber and a plurality of regenerators, which in each case have a regenerator chamber that communicates with the combustion chamber and have a heat exchanger arranged therein. The raw gas is supplied into the RTO device through the raw gas line in the raw gas line system, which connects the heat exchanger to the waste air purification device. A clean gas line for discharging clean gas is then provided to the RTO device, wherein a regenerator chamber of a regenerator, in each case independently of the regenerator chambers of the other regenerators, can be selectively attached to the raw gas line and disconnected from the raw gas line via an adjustable raw gas shut-off device as well as selectively attached to the clean gas line and disconnected from the clean gas line, both via an adjustable clean gas shut-off device.

It is also advantageous if the process plant has a cleaning line attached to the supply line, which cleaning line is used to receive cleaning gas from the regenerator chambers, wherein the cleaning line has regenerator chamber connection points assigned in each case to the different regenerator chambers and wherein the regenerator chamber of each of the regenerators can be selectively connected to or disconnected from its assigned regenerator chamber connection point of the cleaning line in each case independently of the regenerator chambers of the other regenerators via an adjustable gas flow control device, and wherein the cleaning line opens into the raw gas line between the kiln and the separating device. In this way, the regenerative oxidation of raw gas in an environmentally friendly continuous operation of the process plant is made possible.

Preferably, the process plant includes means for adjusting the quantity of hot gas supplied to the calciner. In particular, it is advantageous if the process plant has at least one device for adjusting the quantity of hot gas flowing through the hot gas line system per unit of time.

It should be noted that the process plant can include a device for adjusting the quantity of hot gas flowing through the hot gas line system per unit of time. The kiln can be designed as a rotary kiln, for example.

Examples disclosed herein also extend to the use of the above-mentioned process plant in a cement plant for converting input material in the form of crushed limestone mixed with aggregates into clinker.

Furthermore, examples disclosed herein extend to a method for converting a solid input material into a solid process product, wherein the input material is continuously supplied into a calciner and heated therein to transform the input material into an intermediate product, wherein the intermediate product is converted into the process product in a kiln by means of thermal treatment with the release of raw gas, wherein the raw gas is flowed through the calciner for the transfer of raw gas heat to the input material, and wherein the process product is cooled after the thermal treatment by means of a cooling gas containing oxygen, for example fresh air, wherein the cooling gas is heated to form hot gas, wherein the raw gas is mixed with the heated hot gas after flowing through the calciner and then supplied to a waste air purification device for oxidizing raw gas.

It is advantageous if the input material is supplied into the calciner through a heat exchanger, which acts as a precalciner, wherein the raw gas is flowed from the calciner into the heat exchanger for the transfer of raw gas heat to the input material and wherein the raw gas is mixed with the hot gas after flowing through the heat exchanger and supplied to a waste air purification device for oxidizing the raw gas.

Examples disclosed herein also extend to a method for purifying raw gas produced during the manufacture of cement, which is supplied to a waste air purification device designed as an RTO device, wherein the oxygen content and the temperature of the raw gas supplied to the waste air purification device are adjusted by mixing the raw gas with fresh air heated in a clinker cooler.

The waste air purification device can be designed as an RTO device for regenerative thermal raw gas oxidation, which RTO device includes a combustion chamber and regenerators.

It is advantageous if the raw gas is guided through an SNCR device, which is used to convert the nitrogen oxides and ammonia contained in the raw gas into molecular nitrogen and water.

An advantageous embodiment of the method is that the hot gas can be mixed with the raw gas after it has passed through the SNCR device. It is advantageous if the raw gas is mixed with purge gas from the device for the regenerative thermal oxidation of raw gas. In particular, it is advantageous if solid particles are separated from the raw gas before it is supplied into the device for the regenerative thermal oxidation of raw gas. In particular, it is advantageous if the hot gas from the cooling device is mixed with the raw gas after it has passed through a raw gas cooling device arranged between the heat exchanger and the waste air purification device.

It should be noted that the input material can be crushed limestone mixed with aggregates and the end product can be clinker.

In the following, examples disclosed herein are explained in more detail with reference to the embodiments shown in schematic form in the figures.

### BRIEF DESCRIPTION OF THE DRAWINGS

FIG. 1A, B show a cement plant with a process plant for converting crushed limestone mixed with aggregates into clinker, with an SNCR device and with a waste air purification device designed as an RTO device for purifying raw gas;

FIG. 2 shows a section of the process plant in the cement plant with a heat exchanger; and

FIG. 3 shows a partial view of the process plant in the cement plant with the waste air purification device.

### DETAILED DESCRIPTION

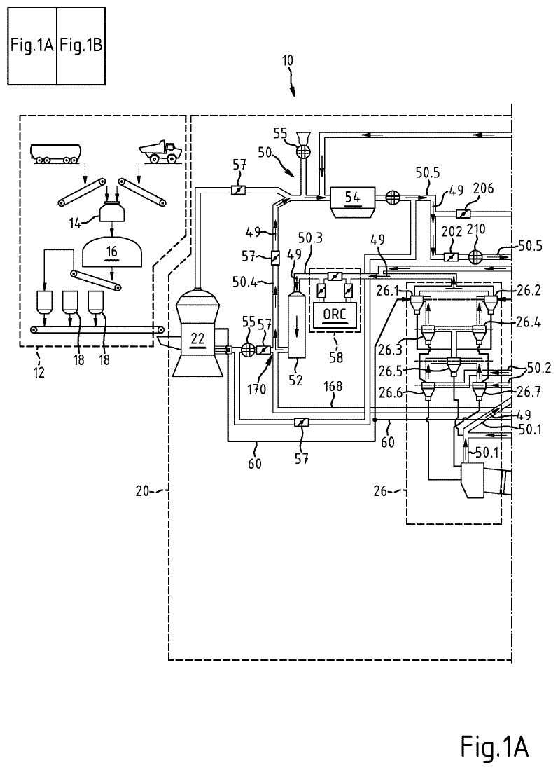

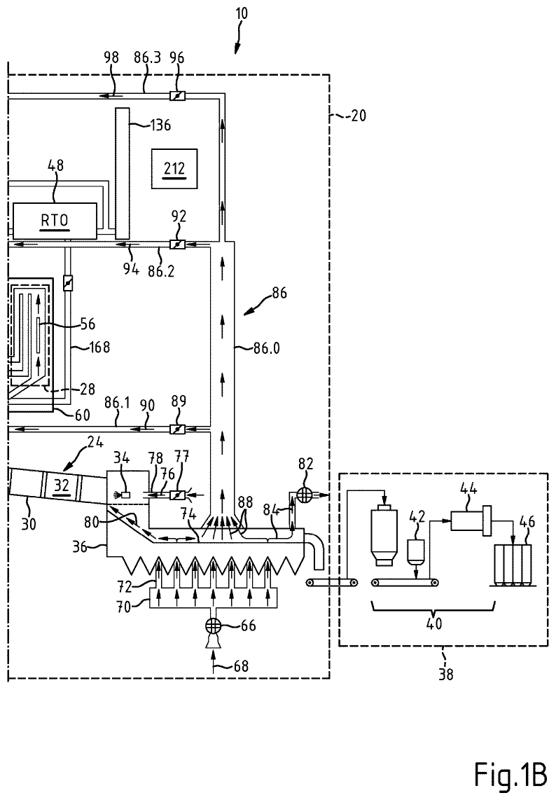

The cement plant 10 shown in FIG. 1 has a raw material preparation stage 12 in which limestone and clay are combined, coarsely crushed in a crushing plant 14 and stored in a raw stone store 16 as a premixed raw material. Aggregates from the silos 18 can be added to the stored, premixed raw material.

There is a process plant 20 in the cement plant 10. It is used to convert the premixed raw material from the raw material preparation stage 12, which raw material has been mixed with aggregates, into clinker, which the process plant 20 generates as a process product. The process plant 20 has a raw material mill 22, which is used to finely grind the premixed raw material mixed with aggregates under a hot gas atmosphere in order to provide solid input material in the form of raw meal.

The process plant 20 includes a kiln 24, to which the raw meal heated in a heat exchanger 26 and in a calciner 28 is supplied. The heated raw meal, also known as furnace meal or hot meal, forms an intermediate product in the process plant. This intermediate product is converted into clinker in the kiln 24 at a temperature T of up to T≈1,450° C., wherein raw gas is released.

The kiln 24 is designed as a so-called rotary kiln. It includes a rotary tube 30 with a furnace chamber 32 and has a burner 34. The kiln 24 is connected to a cooling device 36, which is used to cool the clinker generated in the kiln 24.

In the cement plant 10, there is a final stage 38, which has a clinker processing stage 40, in which cooled clinker can be mixed with aggregates such as gypsum from a silo device 42 and ground in a clinker mill 44, in order to then make it available as cement at a logistics station 46 for transportation to customers.

The process plant 20 has a waste air purification device 48, which is used to purify pollutants from the raw gas of the kiln 24. The waste air purification device 48 is designed as an RTO device. Thus, it is designed for purifying supplied raw gas by means of regenerative thermal raw gas oxidation. In the process plant there is a raw gas line system 50, which is designed to transport the waste air from the kiln 24 into the waste air purification device 48 according to the direction of flow indicated by means of the arrows 49.

A raw gas cooling device 52 designed as a cooling tower and a separating device 54 are arranged in the raw gas line system 50. The raw gas line system 50 has a first raw gas line 50.1 designed as a connecting channel, which the kiln 24 is designed to supply raw gas from its furnace chamber 32 into the calciner 28. The calciner 28 is attached to the heat exchanger 26 by means of second raw gas lines 50.2. The heat exchanger 26 receives hot raw gas from the calciner 28 through the second raw gas lines 50.2. The heat exchanger 26 is used to transfer the heat contained in the raw gas to the raw meal. It acts as a precalciner, in which the raw meal is heated in an oxygen-containing atmosphere.

The heat exchanger 26 is connected to the raw gas cooling device 52 by a third raw gas line 50.3 in the raw gas line system 50, which third raw gas line is designed as a raw gas transport channel. In the raw gas cooling device 52, the temperature of the raw gas is lowered by injecting water. From the raw gas cooling device 52, the raw gas in the raw gas line system 50 passes through a fourth raw gas line 50.4, also designed as a raw gas transport channel, to the separating device 54. The separating device 54 is used to separate solid particles from the raw gas supplied to it. By means of the raw gas cooling device 52, it can be achieved that the temperature T of the raw gas introduced into the separating device 54 is lowered to a value, for example T≈250° C., which ensures trouble-free operation of the separating device 54 and ensures that it is not damaged.

The separating device 54 is connected to the waste air purification device 48 in the raw gas line system 50 by a fifth raw gas line 50.5. The raw gas line 50.5 is used to supply the raw gas freed of solid particles into the waste air purification device 48. Blowers 55 and flow control devices 57 are arranged in the raw gas line system 50 to control the raw gas flow.

There is an SNCR device 56 in the calciner 28. In the SNCR device 56, ammonia is injected, which reacts with harmful nitrogen monoxide (NO) and nitrogen dioxide (NO2) in the raw gas flowing through the calciner 28 at a reaction temperature, which is preferably 850° C. to 1,100° C., to form predominantly harmless molecular nitrogen (N2) and water.

An ORC system 58 is arranged in the raw gas line system 50 for converting heat into electrical or mechanical energy. Raw gas from the third raw gas line 50.3 can be guided through the ORC system 58. It should be noted that, in principle, the process plant 20 in the cement plant 10 can also be designed without such an ORC system 58.

After storage and homogenization, the raw meal ground in the raw material mill 22 is continuously discharged to the heat exchanger 26 of the process plant 20 as furnace meal via a transport line 60.

The heat exchanger 26 in the process plant 20 is designed as a cyclone heat exchanger. The heat exchanger has cyclones 26.1 to 26.7, which are attached to heat exchanger lines for raw gas, which communicate with the second raw gas lines 50.2 and with the third raw gas line 50.3 in the raw gas line system 50 of the process plant 20.

The raw meal discharged to the heat exchanger 26 via the transport line 60 is supplied to the cyclones 26.1 and 26.2. The cyclones 26.1 to 26.7 in the heat exchanger 26 act as heat exchanger units, in which heat is transferred to the raw meal in counterflow to the raw gas flowing out of the kiln 24. As a result, a preheating of the raw meal with the simultaneous cooling of the raw gas is effected. The fuels supplied via the calciner 28 and the raw gases from the kiln 24 provide the energy for releasing the CO₂ from the furnace meal at a temperature T≈870° C. This produces hot meal from the furnace meal as an intermediate product that is more than 90% deacidified compared to the furnace meal.

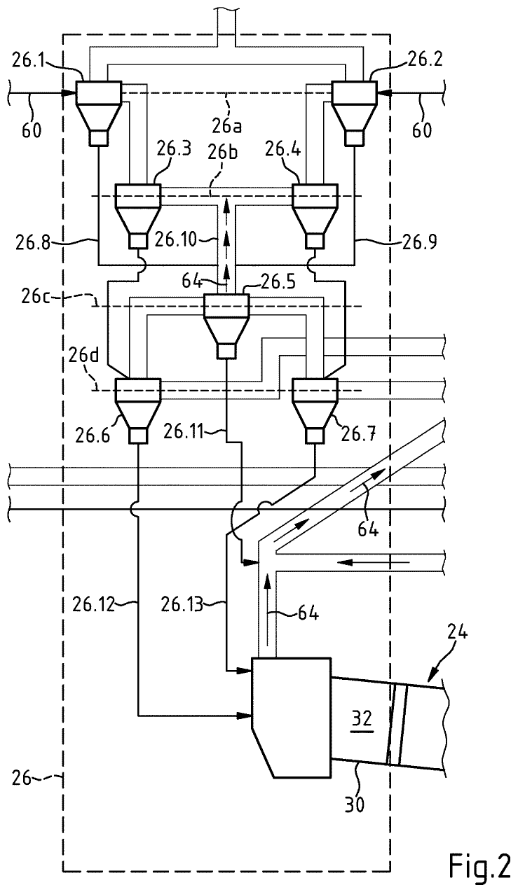

FIG. 2 shows a section of the process plant 20 in the cement plant 10 with the heat exchanger 26.

In the cyclones 26.1 to 26.7 of the heat exchanger 26 and in the calciner 28, the input material is heated with raw gas in a co-current flow after transportation, wherein solids entrained in the raw gas are separated out and enter the kiln 24.

The cyclones 26.1, 26.2 and 26.3, 26.4, the cyclone 26.5 and the cyclones 26.6 and 26.7 are in each case arranged in different cyclone planes 26a, 26b, 26c and 26d, in which the temperature of the raw gas from the calciner 28 flowing through the cyclones 26.1 to 26.7 decreases from the cyclone plane 26d towards the cyclone plane 26a.

The furnace meal discharged to the heat exchanger 26 passes from the transport line 60 into the cyclones 26.1 and 26.2. It is separated from these as a solid and guided via a heat exchanger transport section 26.8, 26.9 into a heat exchanger line 26.10 for raw gas upstream of the cyclone 26.5, through which raw gas flows out of the cyclone 26.5 into the cyclones 26.3 and 26.4 in the direction of flow indicated by the arrows 62. The furnace meal separated in the cyclone 26.5 and heated by means of heat from the raw gas is guided through a heat exchanger transport section 26.11 into the first raw gas line 50.1 of the raw gas line system 50.

The raw gas flowing from the kiln chamber 32 of the kiln 24 in the direction of the arrows 64 moves preheated raw meal from the heat exchanger transport section 26.11 into the calciner 28. This furnace meal then passes from the calciner 28 via the second raw gas lines 50.2 to the cyclones 26.6 and 26.7, which are in each case attached to the kiln 24 by a heat exchanger transport section 26.12, 26.13. In this way, the raw meal separated in the cyclones 26.6 and 26.7 enters the kiln 24 as furnace meal or hot meal. There, it is moved further in the direction of the burner 34 in the kiln 24 while the rotary tube 30 rotates, wherein the hot meal is converted into clinker as the process product.

The process product of clinker is continuously supplied from the kiln 24 to the cooling device 36. In the cooling device 36, fresh air drawn in by means of a plurality of blowers 66 in the direction of the arrow 68 is conveyed via an air register 70 through air outlets 72 to the process product moving over a grate 74 in order to cool it, wherein the fresh air becomes hot air by transferring heat.

Fresh air enters the kiln 24 in the direction of the arrows 76 through a fresh air line 78, in which a flow control device 77 is arranged, as so-called primary air. This fresh air flows through the burner 34 directly into its main flame. In addition, fresh air from the cooling device 36 enters the kiln 24 in the direction of the arrows 80 via the grate 74 as so-called secondary air into the burner 34.

A portion of the hot waste air from the cooling device 36 is drawn out of the system via a controllable fan 82 in a direction of flow corresponding to the arrows 84, which allows for stabilization of the gas flows in the process plant 20.

In the process plant 20, there is a hot gas line system 86, which is used for guiding hot gas in the form of hot air generated from fresh air in the cooling device 36. The hot gas line system 86 has an air guide channel 86.0, into which the fresh air heated to hot air in the cooling device 36 enters in the direction of flow indicated by the arrows 88.

A first hot gas line 86.1 for tertiary air, which is attached to the first raw gas line 50.1 in the raw gas line system 50, is connected to the air guide channel 86.0 in the hot gas line system 86. The hot gas line 86.1 includes a flow control device 89, preferably in the form of a flap, which is a device for adjusting the hot gas flowing through the hot gas line 86.1 per unit of time, and allows for hot air from the cooling device to be supplied to the calciner 28 in the direction of flow indicated by the arrows 90 in the first raw gas line 50.1 of the raw gas line system 50 as so-called tertiary air, which is rich in oxygen.

The hot gas line system 86 has a second hot gas line 86.2 for quaternary air, which connects the air guide channel 86.0 to the third raw gas line 50.3 in the raw gas system 50 between the heat exchanger 26 and the raw gas cooling device 52. The second hot gas line 86.2 also includes a flow control device 92, preferably in the form of a flap. It allows for the supply of oxygen-rich hot air from the cooling device 36 in the direction of flow indicated by the arrows 94 into the third raw gas line 50.3 as so-called quaternary air.

The hot gas line system 86 also includes a third hot gas line 86.3 for quaternary air in the form of hot air, which is rich in oxygen. The hot gas line 86.3 connects the air guide channel 86.0 with the fourth raw gas line 50.4 in the raw gas system 50 between the raw gas cooling device 52 and the separating device 54. The third hot gas line 86.3 includes a flow control device 96, preferably in the form of a flap. It allows for the supply of hot air from the cooling device 36 in the direction of flow indicated by the arrows 98 into the fourth raw gas line 50.4. This hot air is also known as quaternary air.

The blowers 66, the fan 82 and the flow control devices 89, 92 and 96 are devices for adjusting the hot gas flowing through the hot gas line system 86 per unit of time. By controlling these devices, the fresh air supply to the kiln 24, the calciner 28 and the raw gas cooling device 52 and the waste air purification device 48 can be adjusted.

In this way, it can be achieved that fresh air heated by the hot gas lines 86.2 and 86.3 in the cooling device 36 can be supplied as quaternary air in the form of hot air downstream of the heat exchanger 26 or directly upstream of the separating device 54 into the raw gas flowing in the raw gas line system 50, in order to provide thermal energy and oxygen for thermal post-combustion in the waste air purification device 48. In the plant, by adjusting the magnitude of the flow of fresh air drawn in by means of the blowers 66 in the direction of arrow 68, it can be ensured that the temperature T of the quaternary air does not exceed 600° C. This ensures that carbon monoxide (CO) included in the raw gas flowing through the raw gas line system 50 cannot ignite locally.

At least largely autothermal operation is desirable for the waste air purification device 48, which is designed as an RTO device, because it then requires little or no additional external energy for purifying the waste air.

In the process plant 20, this can be achieved by supplying the waste air purification device 48 with raw gas containing carbon monoxide, which is post-combusted in the waste air purification device 48. The carbon monoxide required for post-combustion in the waste air purification device is generated in the process plant by incomplete combustion in the calciner 28 by adjusting the quantity of hot air supplied per unit of time to the calciner 28 through the hot gas line 86.1 as tertiary air to a correspondingly low level by means of the flow control device 89.

In order to effect incomplete combustion in the calciner 28, the quantity of fresh air introduced into it through the hot gas line 86.1 per unit of time as tertiary air must be less than in the case of complete or largely complete combustion in the calciner 28, in which no or only little carbon monoxide is produced.

Reducing the quantity of hot air flowing through the hot gas line 86.1 as tertiary air per unit of time causes the quantity of gas flowing through the calciner 28 per unit of time to decrease in the process plant 20. If less tertiary air is supplied to the calciner 28 per unit of time than is required for complete combustion therein, the total quantity of gases flowing through the calciner 28 per unit of time and thus their flow velocity in the calciner 28 decreases.

Therefore, reducing the hot air guided as tertiary air in the hot gas line 86.1 has the positive effect of increasing the dwell time for the raw meal in the calciner 28 and in the heat exchanger 26, which results, on the one hand, in improved energy transfer from the raw gas into the raw meal and, on the other hand, in less energy being wasted from the furnace system formed by the kiln 24 and the calciner 28 due to a lower gas quantity and lower temperatures in the raw gas flow.

The flow control devices 89, 92, 96 enable the quantity of hot air generated in the cooling device 36 and flowing through the hot gas lines 86.1, 86.2 and 86.3 to be precisely adjusted, in order to, for example, ensure the desired autothermal operation of the waste air purification device 48 designed as an RTO device and to be able to adapt the quantity of hot air flowing through the hot gas lines 86.1, 86.2 and 86.3 to different operating states of the process plant 20.

For example, by feeding hot air flowing through the second hot gas line 86.2 into the third raw gas line 50.3 of the raw gas line system 50 between the heat exchanger 26 and the ORC system 58, it can be achieved that, even with a reduced supply of fresh air into the calciner 28 and an associated reduced flow of raw gas from the heat exchanger with a reduced heat content, the heat of the gas flowing through the raw gas line 50.3 can be utilized for conversion into, for example, electrical energy in the ORC system 58.

The third hot gas line 86.3 allows hot air to be supplied into the fourth raw gas line 50.4 of the raw gas line system so that the waste air purification device 48 can be supplied directly with hot air and thus with oxygen from the cooling device 36. By adjusting the magnitude of the flow of fresh air drawn in by blower 66 in the direction of arrow 68, it is possible to ensure that the temperature T of the quaternary air does not exceed 600° C. here either, so that carbon monoxide (CO) contained in the raw gas does not ignite spontaneously.

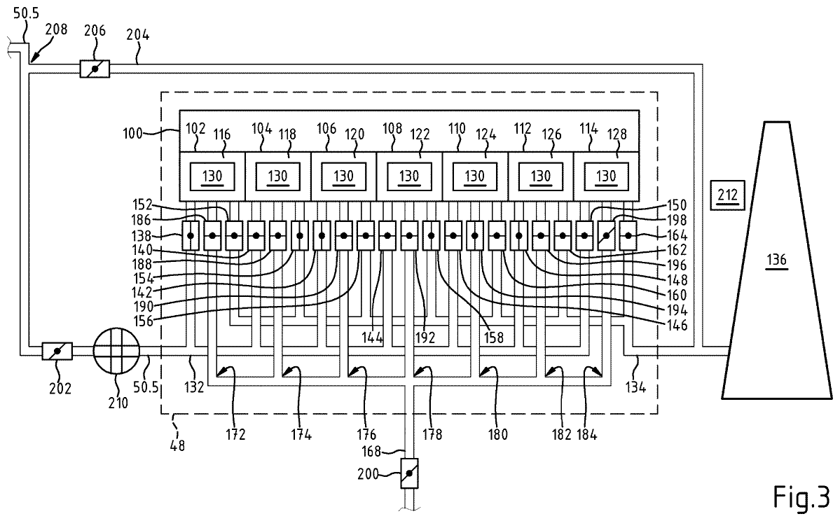

FIG. 3 is a partial view of the process plant 20 in the cement plant 10 with the waste air purification device 48 designed as an RTO device. The waste air purification device 48 includes a combustion chamber 100 and has at least three, optimally seven or more regenerators 102, 104, 106, 108, 110, 112 and 114, which in each case have a regenerator chamber 116, 118, 120, 122, 124, 126 and 128 that communicates with the combustion chamber 100 and have a heat exchanger 130 arranged therein, which is made of ceramic moldings. The waste air purification device 48 is supplied with raw gas from the raw gas line system 50 through the fifth raw gas line 50.5 into a line 132 for raw gas. For the discharge of clean gas, there is a clean gas line 134 in the waste air purification device 48, which clean gas line is attached to a stack 136. In the waste air purification device 48, the regenerator chambers 116, 118, 120, 122, 124, 126 and 128 of the regenerators 102, 104, 106, 108, 110, 112 and 114 can in each case be independently attached to the line 132 for raw gas or disconnected from the line 132 for raw gas by means of an adjustable raw gas shut-off device 138, 140, 142, 144, 146, 148 and 150. Accordingly, the regenerator chambers 116, 118, 120, 122, 124, 126, 128 of the regenerators 102, 104, 106, 108, 110, 112 and 114, by means of an adjustable clean gas shut-off device 152, 154, 156, 158, 160, 162, 164, can each be independently attached to the clean gas line 134 and disconnected therefrom.

There is a cleaning line 168 in the waste air purification device 48. The cleaning line 168 is attached to the raw gas line system 50 at a connection point 170 in the process plant 20. This connection point 170 is located between the calciner 28 and the separating device 54. The cleaning line 168 is used to receive cleaning gas from the regenerator chambers 116, 118, 120, 122, 124, 126 and 128. The cleaning line 168 has regenerator chamber connection points 172, 174, 176, 178, 180, 182 and 184 in each case assigned to the various regenerator chambers 116, 118, 120, 122, 124, 126 and 128. The regenerator chambers 116, 118, 120, 122, 124, 126 and 128 of each of the regenerators 102, 104, 106, 108, 110, 112 and 114, in each case independently of the regenerator chambers of the other regenerators, can be selectively connected to or disconnected from the assigned regenerator chamber connection point 172, 174, 176, 178, 180, 182 and 184 of the cleaning line 168 in the waste air purification device 48 via adjustable gas flow control devices 186, 188, 190, 192, 194, 196 and 198. Instead of adjustable gas flow control devices, alternative adjustment devices can also be used to adjust the volume flow, for example shut-off devices with a defined cross section. Each gas flow control device 186, 188, 190, 192, 194, 196 and 198 allows for the adjustment of different opening cross sections for passage of gaseous fluid.

A cleaning gas flow control device 200 is arranged in the cleaning line 168 for adjusting the discharge of gaseous fluid from the regenerator chambers 116, 118, 120, 122, 124, 126 and 128 of the regenerators 102, 104, 106, 108, 110, 112 and 114, i.e. a control device by means of which the flow of gaseous fluid from the regenerator chambers 116, 118, 120, 122, 124, 126 and 128 through the cleaning line 168 can be adjusted. In the waste air purification device 48, the cleaning line 168 is also used to receive purge gas flowing through the regenerator chambers 116, 118, 120, 122, 124, 126 and 128. Alternatively, in a modified embodiment of the waste air purification device, the purge gas can also be attached to a separate or common purge air line via separate shut-off devices. The return of the purge gas can be effected either to the same location as the cleaning air or to another location upstream of the waste air purification device. It is also possible to reverse the purge direction of the purge gas, for example with preheated fresh air through the purge gas connection in the direction of the RTO combustion chamber.

An adjustable shut-off device 202 is arranged in the raw gas line 50.5, which is used for releasing or shutting off the supply of raw gas into the regenerator chambers 116, 118, 120, 122, 124, 126 and 128 of each of the regenerators 102, 104, 106, 108, 110, 112 and 114.

In addition to the waste air purification device 48 designed as an RTO device, there is a raw gas bypass line 204 connected to the stack 136 in the process plant 20, which communicates with the raw gas line 50.5 through a raw gas line connection point 208 arranged on a side of a shut-off device 206 facing the separating device 54. In the raw gas line 50.5, there is a raw gas supply blower 210 for supplying raw gas to the regenerator chambers 116, 118, 120, 122, 124, 126 and 128. It should be noted that in a modified process plant 20, the raw gas line 50.5 can include a further raw gas supply blower or a plurality of raw gas supply blowers. Each raw gas supply blower 210 has a pressure side facing the regenerator chambers 116, 118, 120, 122, 124, 126 and 128 and a suction side facing the separating device 54.

A control device 212 for controlling the raw gas shut-off devices 138, 140, 142, 144, 146, 148 and 150, the clean gas shut-off devices 152, 154, 156, 158, 160, 162 and 164 and the gas flow control devices 186, 188, 190, 192, 194, 196 and 198 is assigned to the waste air purification device 48. The control device 212 makes it possible to operate the waste air purification device 48 in a normal operating mode, in a maintenance operating mode and in a cleaning mode, as well as optionally in other modes.

It should be noted that the configuration of the gas flow control described here is only an example of a typical position. The control of the containers changes sequentially during plant operation and can be interconnected in any conceivable configuration with regard to their arrangement. The only distinguishing feature is that a number of containers are in raw gas mode, different containers are in clean gas mode and the remaining containers are either in flushing mode, cleaning mode or maintenance mode.

In the normal operating mode of the waste air purification device 48, the raw gas loaded with pollutants flows through first preheated regenerators 102, 104, 106, 108, 110, 112 and 114 in one of the regenerator chambers 116, 118, 120, 122, 124, 126 and 128, which is filled with ceramic moldings as heat exchangers. The raw gas preheated here then enters the combustion chamber 100 of the waste air purification device 48, where complete oxidation of the pollutants takes place. The heat of combustion released in the process reduces the required burner output in proportion to the pollutant content. This allows autothermal operation above a certain pollutant concentration, where no additional energy is required to maintain the temperature in the combustion chamber 100 at a temperature level necessary for oxidation. The cleaned, hot waste gas then flows as clean gas through second regenerators 102, 104, 106, 108, 110, 112 and 114 in the waste air purification device 48 and releases its heat content to the heat exchanger in the corresponding regenerator chambers 116, 118, 120, 122, 124, 126, 128 before the clean gas is released to the atmosphere via a stack. This operating state is maintained until the preheat temperature of the first preheated regenerators 102, 104, 106, 108, 110, 112 and 114 decreases. The direction of flow is then switched by means of the control device 212 after a predetermined time interval such that the uncleaned raw gas then flows through the last preheated second regenerators 102, 104, 106, 108, 110, 112, or 114 into the waste air purification device 48 and, after oxidation, reheats the next regenerator of the waste air purification device 48.

In order to prevent a certain quantity of raw gas from immediately entering the clean gas line 134 when the direction of flow is reversed, the waste air purification device 48 includes a seventh regenerator 102, 104, 106, 108, 110, 112, and 114 with a regenerator chamber 116, 118, 120, 122, 124, 126, 128. While raw gas enters the first three regenerator chambers and clean gas exits the second three regenerator chambers, a seventh regenerator chamber is purged with waste gas from combustion chamber 100. This pushes the remaining raw gas via the cleaning line 134 into the fourth raw gas line 50.4 of the raw gas line system 50 through the separating device 54 into the fifth raw gas line 50.5. The seventh regenerator chamber is then connected to the clean gas line 134 and a regenerator chamber other than a seventh regenerator chamber is purged with waste gas from the combustion chamber 100. In this way, raw gas slip of the waste air purification device 48 is prevented or at least largely minimized.

During the treatment of the waste gases from the kiln 24 and the calciner 28 in the cement plant 10 in the SCNR device 56, ammonium salts in particular can form which enter the RTO system in a gaseous state and precipitate as liquid and/or solid substances, in particular as a slime in the heat exchangers 130 in the regenerator chambers 116, 118, 120, 122, 124, 126 and 128. In order to ensure that clean and raw gas can alternatively flow through the heat exchangers 130 in the regenerator chambers 116, 118, 120, 122, 124, 126 and 128 without excessive flow losses, the control device 212 allows for the waste air purification device 48 to be operated in a cleaning mode in which the regenerators 102, 104, 106, 108, 110, 112 and 114 are subjected to a temperature increase.

In the cleaning mode, raw gas is in each case supplied alternately from the raw gas line 132 into the regenerator chambers 116, 118, 120, 122, 124, 126 and 128 of a first, third and sixth regenerator 102, 104, 106, 108, 110, 112 and 114, clean gas from the regenerator chambers of a second and fourth regenerator 102, 104, 106, 108, 110, 112 and 114 is introduced into the cleaning gas line 134, purge gas is introduced into the purge gas line 134 from a regenerator chamber of a fifth of the regenerators 102, 104, 106, 108, 110, 112 and 114, and cleaning gas is introduced into the cleaning line 168 from a regenerator chamber of a seventh of the regenerators 102, 104, 106, 108, 110, 112 and 114.

A seventh regenerator chamber of the regenerator chambers 102, 104, 106, 108, 110, 112 and 114 is heated during this operation, so that ammonium salts deposited therein, in particular as slime, liquid or solid partially or completely pass into the gaseous phase and enter through the cleaning line 168 via the raw gas line system 50 into the separating device 54 or are cooled down elsewhere and become solid again, in order to be separated there or elsewhere in the process from the raw gas guided therethrough.

If the fresh air line 78 is blocked or the fresh air supply to the burner 34 is throttled by adjusting the flow control device 77 arranged in the fresh air line 78 or by otherwise adapting it, for example by varying the pressure in the rotary kiln, the fresh air supply to the kiln 24 and thus also to the calciner 28 is reduced. The expulsion of CO₂ from raw meal in the form of limestone meal in the calciner 28 is then effected under oxygen deficiency. However, reducing the tertiary air supplied from the hot gas line 86.1 does not affect the oxygen content in the kiln 24 and this remains unchanged compared to conventional clinker processes. As a result, carbon monoxide is produced in the calciner 28 and the raw gas flow through the calciner 28 is reduced slightly. However, this has no negative effect on the process of cement production from limestone meal, which is fed into the calciner 28 and from there into the kiln 24 as an intermediate product. The cement process is also “in balance,” i.e. the air flow through the cooling device 36 and the rotary tube of the kiln 24, as well as the production output, is not negatively affected if fresh air is not guided through the hot gas lines 86.1, 86.3, but through the hot gas line 86.2 into the raw gas line system 50. By reducing the raw gas flow in the calciner 28, the dwell time for the limestone meal supplied to it is increased, which results in more efficient heat transfer to the limestone meal.

However, the carbon monoxide contained in the raw gas guided through the raw gas line system 50 is available as a fuel for burning the pollutants in the raw gas in the waste air purification device 48 of the process plant 20.

This ensures that the waste air purification device 48 can be operated with reduced or no supply of fuels such as natural gas for the combustion of pollutants in raw gas, wherein the oxygen content is sufficient for converting pollutants in the waste air purification device 48 and the inlet temperature for the raw gas into the waste air purification device 48 is above the acid dew point.

By means of supplying quaternary air from the cooling device 36 for the process product of the process plant 20 in the form of clinker, ideal operating conditions result for the waste air purification device 48, since the raw gas to be cleaned supplied to the waste air purification device 48 also then includes sufficient or largely sufficient combustible components due to the carbon monoxide contained therein and has an oxygen content that ensures the conversion of pollutants in the waste air purification device 48, and at the same time has an inlet temperature that is higher than the acid dew point.

However, it should be noted that the energy consumption of a process plant with a waste air purification device 48 is higher than the energy consumption of a process plant without an RTO device, because the incomplete combustion in the calciner 28 produces carbon monoxide due to the reduction of the tertiary air and the waste air purification device 48 does not require any additional energy for the combustion of raw gas. In the cement plant described above, the specific thermal energy consumption increases due to the waste air purification device 48, for example, by around 20 kcal/kg clinker from 840 kcal/kg to 860 kcal/kg clinker, but the waste air purification device 48 can be operated autothermally or largely autothermally, i.e. without or with reduced natural gas, which is replaced by alternative fuels.

It should also be noted that an alternatively constructed process plant can be designed without the third hot gas line 86.3. In addition, it should be noted that in an alternatively designed process plant, provision can be made to also provide hot air at other connection points between the waste air purification device 48 and the heat exchanger 26 in the raw gas line system 50, wherein measures may have to be taken to reduce the dust content of the hot air.

To summarize examples disclosed herein, the following preferred features in particular should be noted: A process plant 20 for converting a solid input material into a solid process product includes a calciner 28 which is connected to a heat exchanger 26 and to which the input material can be continuously supplied for heating in order to transform it into an intermediate product. In the process plant 20 there is a kiln 24 for converting the intermediate product into the process product by means of thermal treatment, raw gas being produced in doing so. The process plant 20 has a raw gas line system 50 comprising a raw gas line 50.1 which extends from the kiln 24 to the calciner 28 and through which the raw gas from the kiln 24 can flow into the calciner 28 for transferring raw gas heat to the input material, and includes a cooling device 36 for cooling the process product after the thermal treatment in the kiln 24 by transferring heat from the process product to a cooling gas containing oxygen, as a result of which a hot gas containing oxygen is generated. In the process plant 20, there is a waste air purification device 48 for oxidizing raw gas, which is connected to the heat exchanger 26 and the calciner 28 via the raw gas line system 50, wherein a hot gas line system 86 which is used for supplying hot gas generated from the cooling device 36 into the raw gas line system 50 is attached to the raw gas line system 50. Examples disclosed herein also relate to a method for converting a solid input material into a solid process product and to a method for purifying raw gas produced during the manufacture of cement.

List of reference signs

| | |
|---|---|
| 10 | Cement plant |
| 12 | Raw material preparation stage |
| 14 | Crushing plant |
| 16 | Raw stone store |
| 18 | Silo |
| 20 | Process plant |
| 22 | Raw material mill |
| 24 | Kiln |
| 26 | Heat exchanger |
| 26.1, 26.2, 26.3, 26.4, 26.5, 26.6, 26.7 | Cyclone |
| 26.8, 26.9 | Heat exchanger transport section |
| 26.10 | Heat exchanger line |
| 26.11, 26.12, 26.13 | Heat exchanger transport section |
| 26a, 26b, 26c, 26d | Cyclone plane |
| 28 | Calciner |
| 30 | Rotary tube |
| 32 | Furnace chamber |
| 34 | Burner |
| 36 | Cooling device |
| 38 | Final stage |
| 40 | Clinker processing stage |
| 42 | Silo device |
| 44 | Clinker mill |
| 46 | Logistics station |
| 48 | Waste air purification device |
| 49 | Arrow |
| 50 | Raw gas line system |
| 50.1 | First raw gas line |
| 50.2 | Second raw gas line |
| 50.3 | Third raw gas line |
| 50.4 | Fourth raw gas line |
| 50.5 | Fifth raw gas line |
| 52 | Raw gas cooling device |
| 54 | Separating device |
| 55 | Blower |
| 56 | SNCR device |
| 57 | Flow control device |
| 58 | ORC system |
| 60 | Transport line |
| 62 | Arrow |
| 64 | Arrow |
| 66 | Blower |
| 68 | Arrow |
| 70 | Air register |
| 72 | Air outlet |
| 74 | Grate |
| 76 | Arrow |
| 77 | Flow control device |
| 78 | Fresh air line |
| 80 | Arrow |
| 82 | Fan |
| 84 | Arrow |
| 86 | Hot gas line system |
| 86.0 | Air guide channel |
| 86.1 | First hot gas line |
| 86.2 | Second hot gas line |
| 86.3 | Third hot gas line |
| 88 | Arrow |
| 89 | Flow control device |
| 90 | Arrow |
| 92 | Flow control device |
| 94 | Arrow |
| 96 | Flow control device |
| 98 | Arrow |
| 100 | Combustion chamber |
| 102, 104, 106, 08, 110, 112, 114 | Regenerator |
| 116, 118, 120, 122, 124, 126, 128 | Regenerator chamber |
| 130 | Heat exchanger |
| 132 | Raw gas line |
| 134 | Clean gas line |
| 136 | Stack |
| 138, 140, 142, 144, 146, 148, 150 | Raw gas shut-off device |
| 152, 154, 156, 158, 160, 162, 164 | Clean gas shut-off device |
| 168 | Cleaning line |
| 170 | Connection point |
| 172, 174, 176, 178, 180, 182, 184 | Regenerator chamber connection |
| | point |
| 186, 188, 190, 192, 194, 196, 198 | Gas flow control device |
| 200 | Cleaning gas flow control device |
| 202 | Shut-off device |
| 204 | Raw gas bypass line |
| 206 | Shut-off device |
| 208 | Raw gas line connection point |
| 210 | Raw gas supply blower |
| 212 | Control device |
| T | Temperature |

1. A process plant for converting a solid input material into a solid process product, the process plant comprising:
a heat exchanger that is connected to a calciner, wherein the input material can be continuously supplied to the calciner via the heat exchanger for heating to transform the input material into an intermediate product,
a kiln for converting the intermediate product into the process product by thermal treatment, wherein raw gas is produced from converting the intermediate product into the process product,
a raw gas line system having a first raw gas line which extends from the kiln to the calciner and through which the raw gas can flow from the kiln into the calciner,
a cooling device for cooling the process product after the thermal treatment in the kiln by transferring heat from the process product to a cooling gas containing oxygen, as a result of which a hot gas containing oxygen is generated, and
a waste air purification device for oxidizing raw gas, which is connected to the calciner via the raw gas line system, wherein a hot gas line system which is used for supplying hot gas generated from the cooling device to the raw gas line system is attached to the raw gas line system, wherein the waste air purification device is a regenerative thermal oxide (RTO) device for regenerative thermal raw gas oxidation,
wherein the hot gas line system for supplying the hot gas generated in the cooling device communicates through at least one quaternary air hot gas line with at least one raw gas line in the raw gas line system, through which raw gas from the heat exchanger can flow into the waste air purification device.

2. The process plant according to claim 1, wherein the quaternary air hot gas line includes a flow control device for adjusting a flow rate of hot gas generated in the cooling device through the quaternary air hot gas line, to adjust temperature and/or oxygen content of the raw gas flowing through the at least one raw gas line to the waste air purification device, in such a way that the raw gas is prevented from igniting locally in the raw gas line system.

3. The process plant according to claim 1, wherein the at least one raw gas line connects the heat exchanger to a raw gas cooling device arranged in the raw gas line system to cool the raw gas supplied to the waste air purification device.

4. The process plant according to claim 3, wherein an organic rankine cycle (ORC) system is arranged in the raw gas line system, to which raw gas can be supplied from the heat exchanger through the at least one raw gas line and hot gas can be supplied from the at least one quaternary air hot gas line, to convert the heat entrained therein into mechanical and/or electrical energy.

5. The process plant according to claim 3, wherein the at least one quaternary air hot gas line opens into a raw gas line in the raw gas line system, which is used to supply raw gas cooled in the raw gas cooling device to the waste air purification device.

6. The process plant according to claim 1, wherein the hot gas line system for supplying the hot gas generated in the cooling device to the calciner has a tertiary air hot gas line which is connected to the first raw gas line, so that hot gas generated in the cooling device can be supplied through the calciner to the heat exchanger.

7. The process plant according to claim 6, wherein a flow control device for adjusting a quantity of hot gas supplied to the calciner through the tertiary air hot gas line such that carbon monoxide is generated during combustion in the calciner.

8. The process plant according to claim 1, wherein a selective non-catalytic reduction (SNCR) device for purifying raw gas guided through the raw gas line system, which is used to convert nitrogen oxides and ammonia contained in the raw gas into molecular nitrogen and water, wherein the waste air purification device has a combustion chamber and a plurality of regenerators, which each include a regenerator chamber that communicates with the combustion chamber and have a heat exchanger arranged therein, and further including:
a clean gas line for discharging clean gas, wherein a regenerator chamber of a regenerator, in each case independently of regenerator chambers of the other regenerators, can be selectively attached to a line for the supply of raw gas from the raw gas line system and disconnected from the raw gas line as well as selectively attached to the clean gas line via an adjustable clean gas shut-off device and disconnected from the clean gas line, both via an adjustable raw gas shut-off device, and
a cleaning line attached to the line for raw gas, wherein the cleaning line is to receive solid burnout gas from the regenerator chambers, wherein the cleaning line has regenerator chamber connection points in each case assigned to the various regenerator chambers, and wherein the regenerator chamber of each of the regenerators, in each case independently of the regenerator chambers of the other regenerators can be selectively connected to or disconnected from the assigned regenerator chamber connection point of the cleaning line, via an adjustable gas flow control device, and wherein the cleaning line is connected to the at least one raw gas line, through which raw gas from the heat exchanger can flow into the waste air purification device.

9. The process plant according to claim 1, wherein an SCNR device is arranged in the calciner.

10. The process plant according to claim 1, further including a separating device for separating solids from the raw gas flowing from the heat exchanger into the waste air purification device.

11. The process plant according to claim 10, wherein the separating device is a filter, as a particle separator or a cyclone for filtering out solid particles from a gaseous fluid.

12. The process plant according to claim 1, wherein at least one device to adjust a quantity of hot gas flowing through the hot gas line system per unit of time.

13. The process plant according to claim 1, wherein the kiln is a rotary kiln.

14. A use of a process plant according to claim 1 in a cement plant for converting input material in the form of crushed limestone mixed with aggregates into clinker.

15. A method for converting a solid input material into a solid process product, wherein the input material is continuously supplied into a calciner and heated therein to transform the input material into an intermediate product, wherein the intermediate product is converted into the process product in a kiln by thermal treatment with the release of raw gas, wherein the input material is supplied into the calciner through a heat exchanger, which acts as a precalciner, wherein the raw gas is flowed through the calciner for the transfer of raw gas heat to the input material, and wherein the process product is cooled after the thermal treatment in the kiln in a cooling device by a cooling gas containing oxygen, wherein the cooling gas is heated to form hot gas, wherein the raw gas is flowed from the calciner into the heat exchanger for the transfer of raw gas heat to the input material and wherein the raw gas is supplied to a waste air purification device for oxidizing the raw gas through at least one raw gas line in a raw gas line system, wherein the waste air purification device is an RTO device for regenerative thermal raw gas oxidation, wherein the raw gas is mixed with the hot gas after flowing through the calciner and the heat exchanger and supplied to the waste air purification device for oxidizing the raw gas by introducing the hot gas through at least one quaternary air hot gas line into the at least one raw gas line.

16. The method according to claim 15, wherein a flow rate of hot gas generated in the cooling device is adjusted by a flow control device, to thereby adjust a temperature and/or oxygen content of the raw gas supplied to the waste air purification device in such a way that said raw gas cannot ignite locally in the raw gas line system.

17. The method according to claim 15, wherein the waste air purification device is a waste air purification device for regenerative thermal raw gas oxidation, which waste air purification device includes a combustion chamber and regenerators.

18. The method according to claim 17, wherein the raw gas is mixed with purge gas from the waste air purification device for the regenerative thermal oxidation of raw gas and/or in that the raw gas is supplied to the combustion chamber through at least one of the regenerators.

19. The method according to claim 15, wherein the raw gas, after mixing with the hot gas, is guided through an ORC system, which is used to convert heat entrained in the raw gas into mechanical and/or electrical energy.

20. The method according to claim 15, wherein the raw gas is guided through an SNCR device, which is used to convert nitrogen oxides and ammonia contained in the raw gas into molecular nitrogen and water.

21. The method according to claim 15, wherein the hot gas from the cooling device is mixed with the raw gas after it has passed through a raw gas cooling device arranged between the heat exchanger and the waste air purification device.

22. The method according to claim 15, wherein solid particles are separated from the raw gas before it is supplied into the device for the regenerative thermal oxidation of raw gas.

23. The method according to claim 15, wherein the input material is crushed limestone mixed with aggregates and an end product is clinker.

24. The method according to claim 15, wherein carbon monoxide is produced in the calciner.

25. A method for purifying raw gas resulting from manufacturing of cement that flows from a heat exchanger into a raw gas line of a raw gas line system, which is connected to a calciner that receives the raw gas from a kiln to which raw meal heated in the heat exchanger and in the calciner is supplied, to convert the raw meal into clinker at a temperature of up to approximately 1,450 degrees Celsius (° C.), wherein the raw gas is released and wherein the raw gas is fed through the raw gas line system to a waste air purification device including an RTO device, wherein oxygen content and a temperature of the raw gas supplied to the waste air purification device are adjusted so that carbon monoxide contained in the raw gas flowing through the raw gas line system is prevented from igniting locally by mixing the raw gas flowing from the heat exchanger with fresh air heated in a clinker cooler.

26. The method according to claim 25, wherein the flow rate for fresh air heated in the clinker cooler is adjusted by a flow control device to adjust a temperature and/or oxygen content of the raw gas in such a way that the raw gas is prevented from igniting locally in the raw gas line system.

27. The method according to claim 25, wherein carbon monoxide is produced in the calciner.
